(19) United States
(12) Patent Application Publication
(10) Pub. No.: US 2007/0262534 A1
(43) Pub. Date: Nov. 15, 2007

(54) Head gasket for internal combustion engines

(76) Inventor: Ryan Hunter, Palmdale, CA (US)

Correspondence Address: DENNIS W. BEECH (LAW OFFICE OF DENNIS W. BEECH), P.O. BOX 519, MURRIETA, CA, 92564-0519, US

(21) Appl. No.: 10/916,915

(22) Filed: Aug. 12, 2004

(51) Int. Cl. F02F 11/00

(52) U.S. Cl. 277/592

(57) ABSTRACT

The head gasket for internal combustion engines may be used to seal cylinders between a cylinder block and a cylinder head. A head gasket may have multiple holes formed therein. An edge of a cylinder hole in the head gasket may have an annular groove formed therein. A ring may be disposed in the annular groove.

### BACKGROUND OF THE INVENTION

This invention relates to head gaskets for sealing internal combustion engines between the cylinder block and the cylinder head. The new head gasket may be a copper head gasket with wire rings disposed in annular openings or grooves formed in the edges of the apertures of the head gasket.

High performance internal combustion engines may generate combustion pressure sufficient to cause leakage or failure of composition or multilayer metal cylinder head gaskets. One solution may have been to construct the body of the cylinder head gasket using annealed copper that may have superior malleability, elasticity, conductivity and relatively high tensile strength. This usage may require modification of the cylinder block or head by machining a groove for placement of a wire combustion seal. A groove may be machined at the perimeter of the cylinder bore to hold a wire in position around a combustion chamber such that a portion of the wire protrudes from the block or head sealing surface that may cause a higher localized clamp load upon tightening of the cylinder head fasteners to create a gas tight combustion seal. It may be beneficial to have a head gasket that does not require modification of the cylinder block or head for gas combustion sealing in high performance internal combustion engines.

### SUMMARY OF THE INVENTION

The present invention is directed to gaskets for internal combustion engines. A head gasket may have multiple holes formed therein. An edge of a cylinder hole in the head gasket may have an annular groove formed therein. A ring may be disposed in the annular groove.

These and other features, aspects and advantages of the present invention will become better understood with reference to the following drawings, description and claims.

### BRIEF DESCRIPTION OF THE DRAWINGS

FIG. 1 illustrates a partial side elevation cross-sectional view of a head gasket with wire ring inserts according to an embodiment of the invention;

FIG. 2 illustrates a partial top plan view of a head gasket with wire ring inserts according to an embodiment of the invention;

FIG. 3 illustrates a partial side elevation cross-sectional view of a head gasket with laminated elements according to an embodiment of the invention;

FIG. 4 illustrates a tool for cutting a groove in an aperture edge of a head gasket according to an embodiment of the invention;

FIG. 5 illustrates a partial side cross-sectional view of a head gasket, a cylinder block and a cylinder head according to an embodiment of the invention;

FIG. 6 illustrates a partial side elevation cross-sectional view of a head gasket with wire ring inserts according to an embodiment of the invention;

FIG. 7 illustrates a partial side elevation cross-sectional view of a head gasket with a wire ring having a flange according to an embodiment of the invention;

FIG. 8 illustrates a partial side elevation cross-sectional view of a head gasket with a wire ring according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

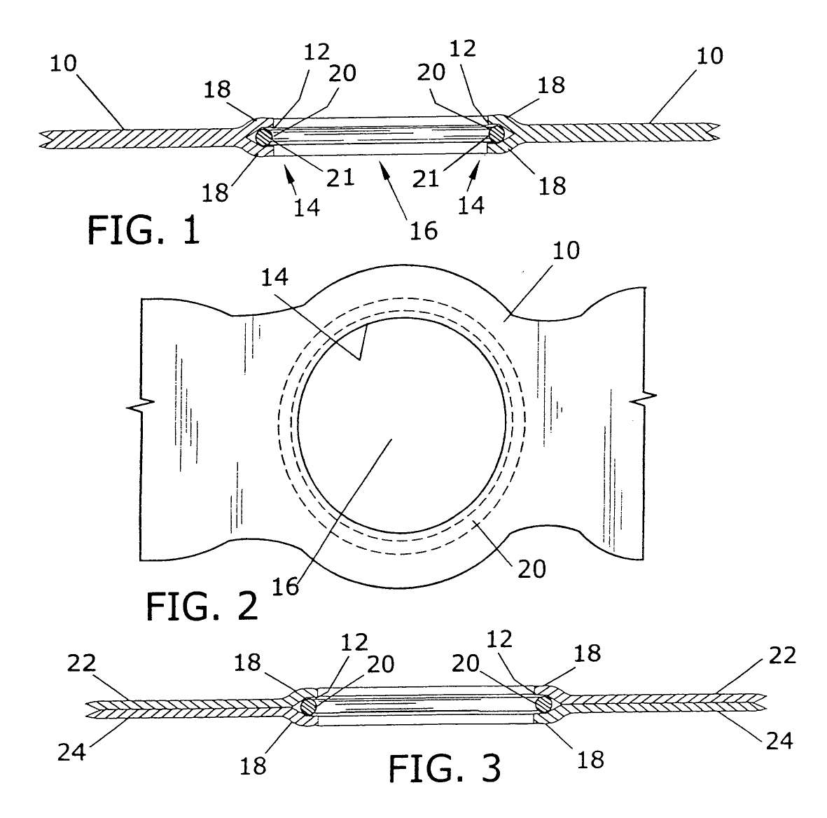

Referring to FIGS. 1 and 2, a head gasket 10 may have an annular groove 12 formed in the edge 14 of apertures 16 that may be cylinder apertures. The groove 12 may be formed in a manner that may create an expanded thickness shoulder portion 18 or flange adjacent the edge 14 relative to the cross-sectional thickness of the body of the head gasket 10. The head gasket 10 may be formed of copper that may be annealed that may have superior malleability, conductivity and relatively high tensile strength as compared to currently used material for head gaskets.

Referring to FIGS. 1, 2 and 5, annealed copper as well as other like materials with similar properties may facilitate the sealing between a cylinder block 30 and a cylinder head 32, particularly in the portion around the cylinders 34 or combustion chambers. A ring 20 that may have a diameter larger than a cylinder 34 may be disposed in the groove 12. The ring 20 may have open ends abutted, welded or other construction as a ring. The ring 20 may be formed of metal wire such as cold drawn 304 stainless steel that may not be annealed or other like property material. The ring 20 may have some springy property.

The ring 20 may be disposed in the groove 12 at a depth to prevent the head gasket 10 material, such as, copper, from enclosing the ring 20 when the head gasket 10 is disposed between a cylinder block 30 and a cylinder head 32 and the head bolts 36 of the engine are tightened. The head gasket 10 material may partially enclose the ring 20 adjacent the cylinder 34 as best viewed in FIG. 5. Use of a wire ring 20 in head gasket 10 may allow head gasket and ring use in areas of an engine cylinder block or head where separation between cylinders or other passages may be too small for application of current wire combustion seals.

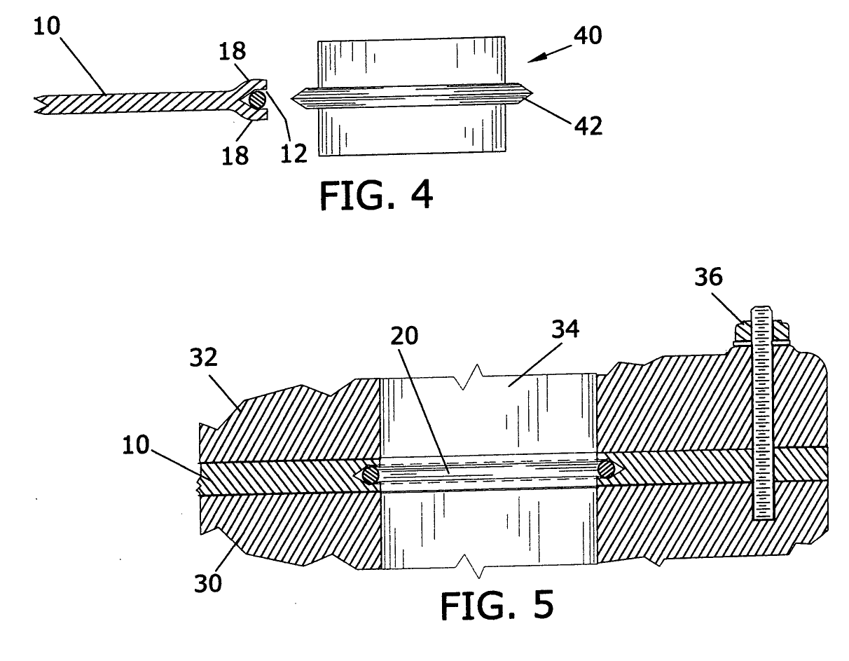

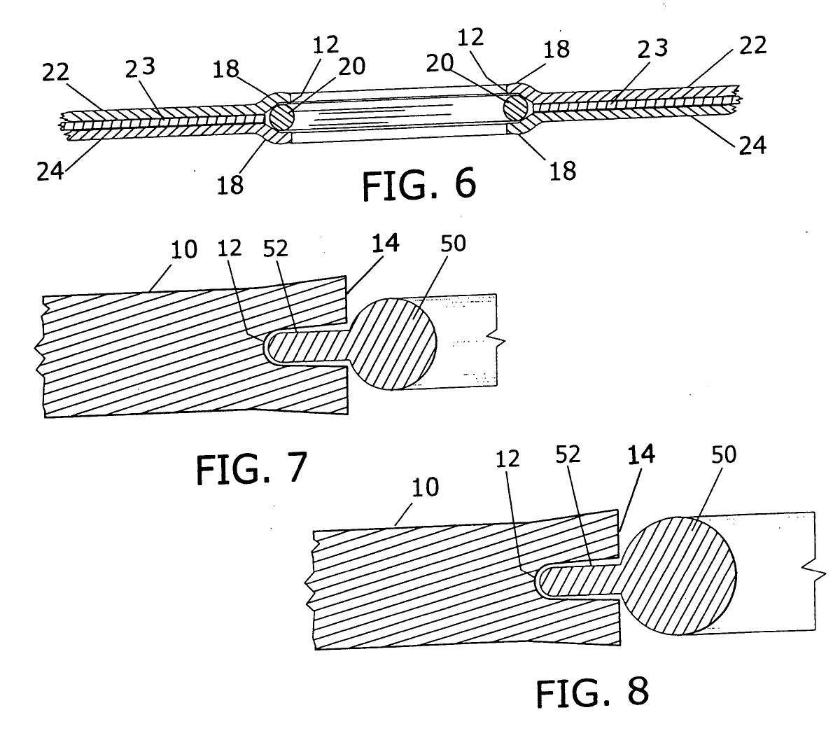

Referring to FIGS. 1, 3 through 6, the groove 12 may be roll formed in the interior perimeter wall or edge 14 of the aperture 16. A tool 40 having a cutting blade 42, as for example a pipe cutting wheel, may be used to form the groove 12. Other methods may also be used, for example, a multiple layer head gasket 10, as best viewed in FIGS. 3 and 6, may be assembled having a first layer 22 and second layer 24 joined by bonding, welding, fastening or the like with a groove 12 formed at the edge 14 of apertures 16 in the head gasket 10. Multiple thickness head gaskets 10 may be used with rings 20 that may allow for adjustment of cylinder head 32 to cylinder block 30 component clearances depending on engine use requirements. Additional head gasket 10 material layers may be included, as for example, a third layer 23 that may have a cylinder aperture 16 diameter greater than that of layers 22, 24 to accommodate placement of ring 20 in annular groove 12 as best viewed in FIG. 6.

Referring to FIGS. 1, 2 and 5, in use, the wire ring 20 may be disposed in the groove 12 and held in place by spring tension or by clinching the shoulders 18 against the ring 20. When the head gasket 10 may be disposed between the cylinder block 30 and cylinder head 32 and the head bolts 36 may be tightened, the ring 20 may resist compression to increase local clamp loading to form a combustion chamber gas seal. Combustion pressure in the cylinder 34 may force the ring 20 disposed in the groove 12 to move against the groove 12 shoulders 18 to maintain a gas seal under elevated compression conditions. Also, should the cylinder head 32 be displaced upwardly from the cylinder block 30 in elevated compression conditions, the head gasket 10 shoulders 18 may spread to maintain contact with the cylinder block 30 and cylinder head 32 to maintain a gas seal of the cylinder 34.

Referring to FIGS. 7 and 8, the ring may be a ring portion 50 having a shoulder or flange 52 wherein the flange 52 may be inserted in an annular groove 12 of a head gasket 10 such that the ring portion 50 may be circumferentially adjacent the edge 14 of the cylinder aperture with the flange 52 clamped in the annular groove 12 when a cylinder block and cylinder head may be assembled with a head gasket 10 therebetween. The diameter of the ring portion 50 inner surface opposite the flange 52 may be approximately the same as a cylinder.

While the invention has been particularly shown and described with respect to the illustrated embodiments thereof, it will be understood by those skilled in the art that the foregoing and other changes in form and details may be made therein without departing from the spirit and scope of the invention.

1. A gasket for internal combustion engines comprising:
a body formed of a single layer of malleable material and having a plurality of apertures formed therein;
an edge of a cylinder aperture of one of said plurality of apertures of said body having an annular groove formed therein; and
a ring disposed in said annular groove.

2. The gasket as in claim 1 wherein said body having a shoulder portion formed adjacent said annular groove wherein said shoulder portion cross-sectional vertical dimension is greater than said body thickness.

3. The gasket as in claim 1 wherein said head gasket is formed of a first layer attached to a second layer.

4. The gasket as in claim 3 wherein there is a third layer intermediate said first layer and said second layer.

5. The gasket as in claim 1 wherein said body is formed of a material having properties of malleability, conductivity and elevated tensile strength.

6. The gasket as in claim 5 wherein said material is annealed copper.

7. The gasket as in claim 1 wherein said ring is formed of a metal wire.

8. The gasket as in claim 7 wherein said ring has a springy property.

9. The gasket as in claim 7 wherein said metal wire is formed of cold drawn nonannealed 304 stainless steel.

10. The gasket as in claim 1 wherein said ring is disposed in said annular groove to prevent said body from enclosing said ring when said gasket is disposed between a cylinder block and a cylinder head that are attached by a plurality of head bolts.

11. The gasket as in claim 1 wherein said ring is retained in said annular groove by a spring force of said ring.

12. The gasket as in claim 1 wherein said ring is retained in said annular groove by clinching of a shoulder portion against said ring.

13. The gasket as in claim 1 wherein said annular groove is roll formed in said edge using a round tool having a cutting blade.

14. The gasket as in claim 1 wherein said ring comprising:
a ring portion having an annular flange; and
said annular flange insertable in said annular groove to position said ring portion circumferentially adjacent said edge of said cylinder aperture wherein said ring portion diameter at a surface opposite said flange is approximately equal to the diameter of a cylinder.

15. A gasket for internal combustion engines comprising:
a single layer malleable copper body having a plurality of apertures formed therein;
an edge of a cylinder aperture of one of said plurality of apertures of said body having an annular groove formed therein and a shoulder portion formed adjacent said annular groove;
a ring formed of a metal wire disposed in said annular groove to prevent said body from enclosing said ring when said gasket is disposed between a cylinder block and a cylinder head that are attached by a plurality of head bolts.

16. A method for head gasket sealing of cylinders between the cylinder block and the cylinder head of internal combustion engines comprising:
providing a malleable copper head gasket having an edge of a cylinder aperture with an annular groove formed therein and a shoulder portion formed adjacent said annular groove;
disposing a ring formed of a metal wire in said annular groove to prevent said head gasket from enclosing said ring when said head gasket is disposed between said cylinder block and said cylinder head that are attached by a plurality of head bolts; and
placing said head gasket between said cylinder block and said cylinder head; and
attaching said cylinder block to said cylinder head by tightening said head bolts sufficiently to deform said shoulder portion about said ring.

17. The gasket as in claim 1 wherein said ring has a convex inner wall.
